(19) United States
(12) Patent Application Publication
(10) Pub. No.: US 2010/0021281 A1
(43) Pub. Date: Jan. 28, 2010

(54) Power management system and method

(75) Inventor: Bryan E. Nelson, Lacon, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/219,597

(22) Filed: Jul. 24, 2008

(51) Int. Cl. G05D 17/00; F01D 21/14; G01L 3/00; F03B 15/06

(52) U.S. Cl. 415/30; 415/13; 701/50; 73/862.321

(57) ABSTRACT

The present disclosure is directed to a method for power management in a machine. The method for power management may include sensing a parameter indicative of a torque applied to a torque consuming device rotatably driven by a power source. The method may further include modifying a quantity of fuel supplied to the power source as a function of the sensed parameter.

### TECHNICAL FIELD

The present disclosure generally relates to power management and, more particularly, modifying power output of a power source as a function of a sensed torque load on the power source.

### BACKGROUND

Machines, such as, for example, wheel loaders, off-highway trucks, and other heavy construction and mining machines are used to perform many tasks. To effectively perform these tasks, the machines require a power source such as a diesel engine, a gasoline engine, a natural gas engine, a turbine engine, or any other type of power source. Such machines may also include a hydraulic power unit such as a pump, motor, and/or transmission configured to transmit an input from the power source into an output to complete these tasks. For example, a hydraulic pump may be configured to convert at least a portion of the power from the engine into a flow of pressurized fluid for driving one or more fluid actuators associated with a ground engaging device or for use in an implement circuit associated with an implement.

Current power management systems do not effectively measure the amount of torque applied to a hydraulic pump and, therefore, do not recognize how much power a hydraulic pump may be consuming. Instead, current power management systems monitor and adjust based on, among other things, engine speed. As a hydraulic load of a hydraulic pump changes, the hydraulic pump requires a greater amount of power from the power source. This contributes to reduce the engine speed. When the engine speed falls below a desired engine speed, the power management system senses the speed change and reacts by increasing the supply of fuel to the engine to counter the decrease in engine speed and maintain the desired engine speed.

Such a power management system may result in detrimental engine emissions. For example, the power management system may overcompensate for a speed decrease due to an increased hydraulic load. In such instances, the over fueling of the engine may produced detrimental emissions that may exceed governmental regulations.

U.S. Pat. No. 6,817,253 (“the '253 patent”) issued to Michael D. Gandrud on Nov. 16, 2004, discloses a hydraulic power unit having torque transducers integrated into the hydraulic power unit. A system controller is communicatively coupled to the torque transducers to use the information provided by the torque transducer to monitor the performance of the hydraulic power unit and control the hydraulic power unit to limit the torque or power required by a power source. Specifically, the controller of the '253 patent is configured to control the hydraulic power unit by reducing the pressure or displacement of the hydraulic power unit in order to prevent over powering the power source such as stalling an internal combustion engine.

While the '253 patent may disclose a method of controlling a load of a hydraulic power unit to limit the power required of a power source, the '253 patent does not compensate for the over fueling of the power source based on load fluctuations of the hydraulic power unit. Specifically, the '253 patent does not disclose a method of modifying a fueling quantity supplied to the power source as a function of the sensed torque on the hydraulic power unit. Therefore, as the pressure or displacement of the hydraulic power unit of the '253 patent is adjusted, the power source may continue to produce undesirable emissions.

The disclosed methods and systems are directed to overcoming one or more of the problems set forth above and/or other problems in the art.

### SUMMARY

In one aspect, the present disclosure is directed to a method for power management in a machine. The method for power management may include sensing a parameter indicative of a torque applied to a torque consuming device rotatably driven by a power source. The method may further include modifying a quantity of fuel supplied to the power source as a function of the sensed parameter.

In another aspect, the present disclosure is directed towards a machine. The machine may include a frame, an engine mounted to the frame, and one or more load devices operatively connected to the engine. The machine may further include a controller in communication with the engine and the one or more load device. The controller may be configured to regulate a quantity of fuel supplied to the engine based on a sensed change in load on the one or more load devices.

In still another aspect, the present disclosure is directed to a method of generating a torque curve associated with a torque consuming device for use in a machine. The method may include measuring a twist angle of a shaft of the torque consuming device upon the application of a load on the torque consuming device, and measuring an actual torque applied to the shaft of the torque consuming device based on the applied load. The method may further include generating the torque curve based on a twist angle versus torque relationship and storing the torque curve on a medium associated with the torque consuming device.

### BRIEF DESCRIPTION OF THE DRAWINGS

FIG. 1 is an illustration of an exemplary machine according to the present disclosure;

FIG. 2 is a cross-sectional illustration of the exemplary hydraulic pump of the exemplary machine of FIG. 1;

FIG. 3 is a flowchart according to an exemplary disclosed embodiment; and

FIG. 4 is a flowchart according to another exemplary disclosed embodiment.

### DETAILED DESCRIPTION

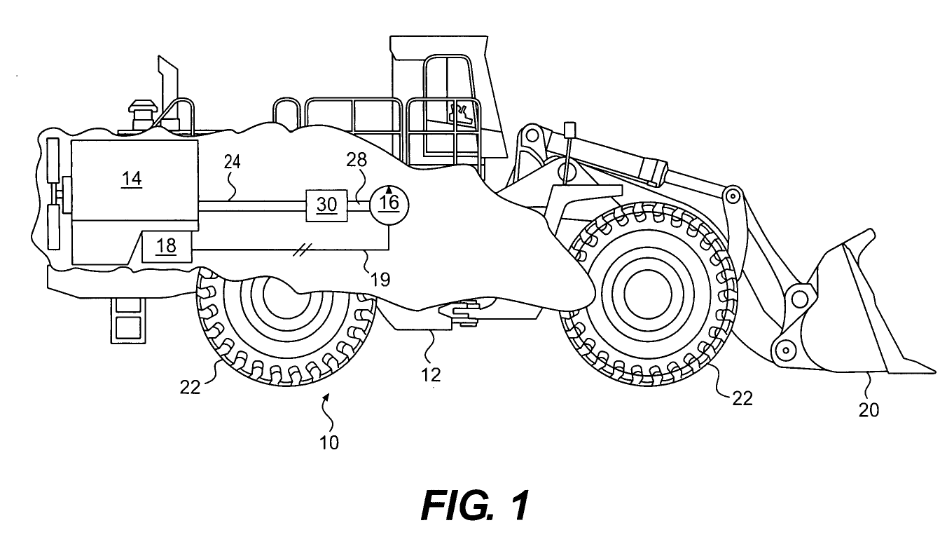

FIG. 1 illustrates an exemplary embodiment of a machine 10. Machine 10 may be a mobile machine that performs some type of operation associated with an industry such as mining, construction, farming, or any other industry known in the art. For example, machine 10 may be an earth moving machine such as a wheel loader, an excavator, a dump truck, a backhoe, a motor grader, or any other suitable machine. Machine 10 may include a frame 12, a power source 14, a hydraulic pump 16, an implement 20, a ground engaging device 22, and a controller 18.

Power source 14 may include an engine such as, for example, a diesel engine, a gasoline engine, a gaseous fuel powered engine such as a natural gas engine, or any other engine apparent to one skilled in the art. The power of power source 14 may be expressed as the product of the torque delivered to an output shaft 24 of power source 14 multiplied by the angular speed of output shaft 24. The angular speed of output shaft 24 may be related to engine speed. As engine speed increases, the angular speed of output shaft 24 may also increase. A decrease in engine speed may produce a corresponding decrease in the angular speed of output shaft 24.

Machine 10 may also include one or more load devices rotatably driven by power source 14. The load device may be a device that applies a load onto power source 14 such as, for example, a torque consuming device. The torque consuming device may be defined as a device that applies a torque load onto power source 14 by consuming torque produced by output shaft 24. The torque consuming device may be a pump, generator, fan, and/or any other device rotatably driven by power source 14. Specifically, a rotating pump shaft 28 of hydraulic pump 16 may be coupled to the output shaft 24 of power source 14 by way of, for example, a gear train 30. Hydraulic pump 16 may include an axial piston pump, a gear pump, a radial piston pump, or any other rotary driven device for pressurizing a flow of fluid known in the art.

Hydraulic pump 16 may be configured to transform an input from power source 14 into an output, such as movement of implement 20, ground engaging device 22, and/or any other change in state of machine 10. Specifically, hydraulic pump 16 may be configured to convert at least a portion of the power from power source 14 into a flow of pressurized fluid for an implement circuit associated with an implement 20 and/or for driving one or more drive motors associated with a ground engaging device 22. Implement 20, may include a blade, scraper, bucket, gripping device, and/or any other suitable implement. Ground engaging device 22 may include a wheel assembly, track type device, and/or any other suitable ground engaging device.

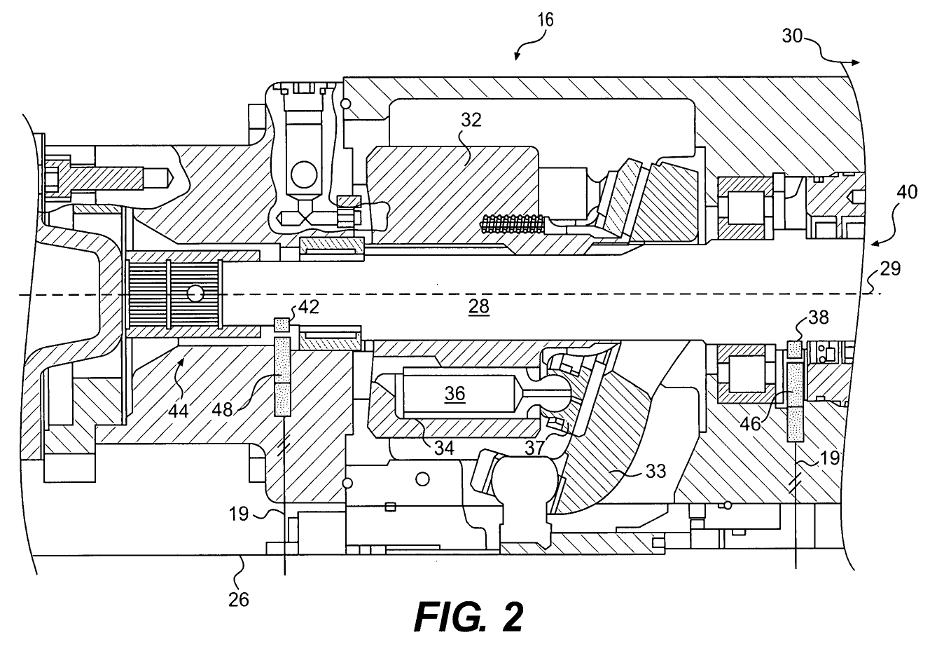

Referring now to FIG. 2, hydraulic pump 16 may include a stationary pump housing 26 and pump shaft 28. As described above, pump shaft 28 may be may be coupled to the output shaft 24 of power source 14 in a manner such that the rotation speed of pump shaft 28 is directly proportional to the rotation speed of the output shaft 24 of power source 14. A barrel 32 may be fixedly attached to pump shaft 28 via a spline engagement so that pump shaft 28 and barrel 32 rotate together. Pump shaft 28 may extend through an opening in proximal end of stationary pump housing 26 and may be rotationally supported by pump housing 26 via a conventional arrangement such as a bearing pair.

Barrel 32 may further include a plurality of piston openings 34 for receiving portions of a plurality of pump pistons 36. Piston openings 34 may be equally angularly spaced about a pump shaft 28 longitudinal axis 29. Piston openings 34 may be sized and oriented to allow for reciprocating movement of pump pistons 36 parallel to longitudinal axis 29 of pump shaft 28. Ends of pump pistons 36 may be seated in a plurality of piston slippers 37 slidably engaging an adjustable, non-rotating swashplate 33 to control the displacement of pump pistons 36 within the piston openings 34. In operation, pump pistons 36 rotate with pump shaft 28 and reciprocate in piston openings 34 as a function of the tilt angle of swashplate 33.

Pump shaft 28 of hydraulic pump 16 may include a first element 38 attached adjacent to a first end 40 of pump shaft 28 located proximate to the input from gear train 30 and power source 14 and on one side of swashplate 33. Pump shaft 28 of hydraulic pump 16 may include a second element 42 fixed to a second end 44 of pump shaft 28 located on the side of swashplate 33 that is opposite the input from gear train 30 and power source 14. In one embodiment, first element 38 may be a first magnet and second element 42 may be a second magnet. In an alternative embodiment, first element 38 may be a first projection and second element 42 may be a second projection. It is to be understood that first element 38 and second element 42 may be any physical configuration or feature on pump shaft 28 that may be detected by a sensor. It is also to be understood that first element 38 and second element 42 may be integral with pump shaft 28 or may be separate components that are attached to pump shaft 28, and that reference herein to the element being “attached” or “coupled” to the pump shaft 28 includes both integral and separately attached elements.

Stationary pump housing 26 may include a first sensor 46 and a second sensor 48 associated with first element 38 and second element 42, respectively, of pump shaft 28. First sensor 46 and second sensor 48 may include, for example, electrical and/or mechanical sensors or any combination thereof. First sensor 46 and second sensor 48 may be configured to detect first element 38 and second element 42, respectively, as they pass during rotation of pump shaft 28. First sensor 46 and second sensor 48 may be configured to generate a signal responsive to first element 38 and second element 42. It is contemplated that signals established by first sensor 46 and second sensor 48 may embody any signal, such as, for example, a pulse, a voltage level, a digital signal, a magnetic field, a sound or light waves, and/or other signal formats known in the art.

First sensor 46 and second sensor 48 may be configured to sense the amount of twist in pump shaft 28 as torque is applied to pump shaft 28. First sensor 46 and second sensor 48 associated with first element 38 and second element 42, respectively, may be positioned to sense the twist in pump shaft 28 between barrel 32 and the portion of pump shaft 28 coupled to the output shaft 24. It will be understood that the position of first sensor 46 and second sensor 48, as shown in FIG. 2, is exemplary, and that first sensor 46 and second sensor 48 may assume any position along pump shaft 28 that may allow first sensor 46 and second sensor 48 to sense a twist in pump shaft 28 between barrel 32 and the portion of pump shaft 28 coupled to the output shaft 24. It is contemplated that multiple sensors may be used to sense the amount of twist in pump shaft 28 to provide a greater resolution of the amount of twist in pump shaft 28. First sensor 46 and second sensor 48 may be additionally configured to sense the rotational speed of pump shaft 28.

Referring back to FIG. 1, controller 18 may be part of the control system for machine 10, and may be configured to receive operating parameters associated with power source 14, hydraulic pump 16, and other machine components. For example, controller 18 may be communicatively coupled, by way of communication links 19, to first sensor 46 and second sensor 48 associated with hydraulic pump 16. Controller 18 may be configured to, among other things, determine a twist angle of the pump shaft 28 based upon a rotational time lag between first element 38 passing first sensor 46 and second element 42 passing second sensor 48.

Controller 18 may be further configured to store data and algorithms related to twists angles, torques, and/or fueling quantities. Such data may be stored in one or more look up tables within controller 18. Alternatively or additionally, portions of the data may be derived from calculations using algorithms stored within controller 18 and based on various machine parameters. In one example, data may be stored in a torque curve for reference. The torque curve may provide torque data as a function of twist angle. In another example, data may be stored in a fuel supply adjustment curve for reference. The fuel supply adjustment curve may provide fueling adjustment data as a function of torque data. It will be apparent to one skilled in the art that a single map may be generated to provide fueling adjustment data as a function of twist angle and other inputs.

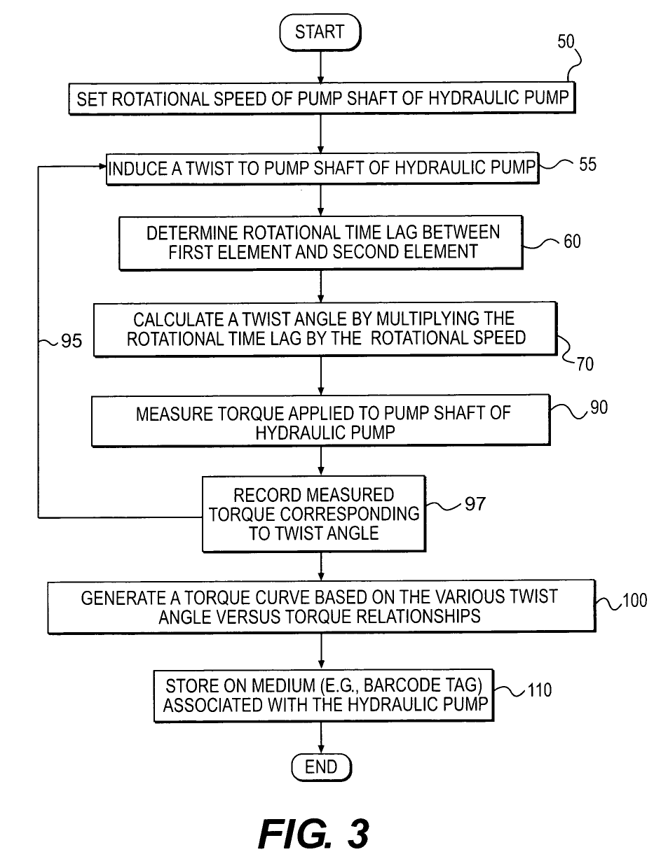

FIG. 3 diagrammatically illustrates, in flowchart form, a method for generating a torque curve associated with a hydraulic pump 16. Torque curves of various hydraulic pumps 16 may differ based on physical properties of, for example, pump shaft 28 of hydraulic pump 16. Therefore, a torque curve may be generated for each hydraulic pump 16 during a performance test after pump production, i.e., end-of-line testing. While certain actions of the process are indicated in FIG. 3, as well as indicated in a particular sequence for purposes of explanation, it should be understood that this is exemplary, and that the sequence of actions may be other than that illustrated in FIG. 3. In addition, the actions that occur also may vary from the exemplary embodiment of FIG. 3.

Referring to FIG. 3, at step 50, pump shaft 28 may be set to rotate at a specified rotational speed (step 50). At step 55, a twist may be induced on pump shaft 28 of hydraulic pump 16 by, for example, a load to hydraulic pump 16. First sensor 46 and second sensor 48 may be used, at step 60, to determine an amount of twist in pump shaft 28 by determining a rotational time lag between first element 38 passing first sensor 46 and second element 42 passing second sensor 48. At step 70, the rotational time lag may be multiplied by the rotational speed of pump shaft 28 to calculate a twist angle. A torque meter such as, for example, a strain gauge may be coupled to pump shaft 28 of hydraulic pump 16. The torque meter may be configured to directly measure the applied torque to hydraulic pump 16, as indicated at step 90. The measured torque may then be recorded, at step 97, as corresponding to the calculated twist angle. As indicated by arrow 95, the method may be repeated by varying the load on hydraulic pump 28 to update the torque applied to hydraulic pump 16, either continuously or at intervals. At step 100, a torque curve may be generated based on the twist angle versus measured torque relationship. As shown in step 110 of FIG. 3, the torque curve may be stored on a medium such as a barcode type tag associated with hydraulic pump 28. The barcode type tag or other medium may be optically or electronically scanned or manually stored into controller 18 of the control system of machine 10 after hydraulic pump 16 has been associated with machine 10. Alternatively, the torque curve may be stored on another medium and provided to controller 18.

Fuel supply adjustment curve may be additionally generated as a function of a torque applied to hydraulic pump 16. Specifically, fuel supply adjustment curve may be generated as a function of machine, power source, and pump parameters to map an adjustment in the quantity of fuel required by power source 14 to maintain engine speed when the load applied to hydraulic pump 16 changes. Fuel supply adjustment curve may be stored on controller 18.

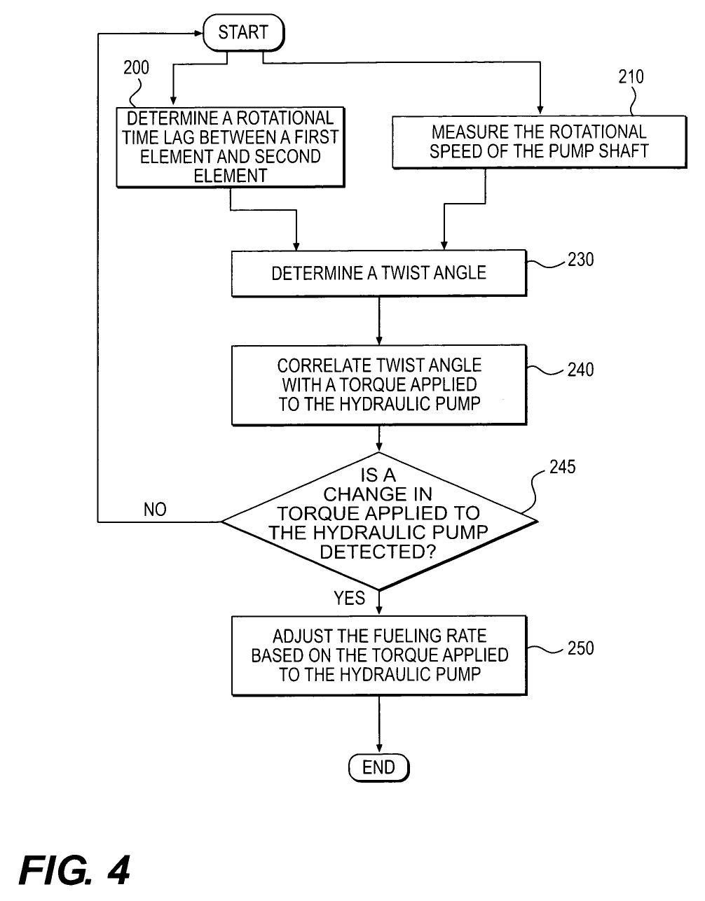

Referring to FIG. 4, controller 18 of machine 10 may be configured to determine a change in torque applied to hydraulic pump 16, and consequently a change in power consumed by hydraulic pump 16. Controller 18 may be further configured to adjust the fueling of power source 14 as a function of the change in torque. In operation, controller 18 may be configured to sense, based on first sensor 46 and a second sensor 48 associated with pump shaft 28 of hydraulic pump 16, a parameter indicative of a torque applied to hydraulic pump 16. Specifically, first sensor 46 and a second sensor 48 may provide data associated with the rotational time lag between first element 38 and second element 42, as shown in step 200, and as described above. In step 210, controller 18 may be further configured to receive data corresponding to the rotational speed of pump shaft 28. In step 230, controller 18 may determine a twist angle of pump shaft 28. For example, controller 18 may be configured to determine the twist angle by multiplying the rotational time lag by the rotational speed of pump shaft 28. In step 240, controller 18 may be further configured to determine a torque applied to hydraulic pump 16 by correlating the obtained twist angle with a torque curve stored in controller 18.

Having the torque applied to hydraulic pump 16, controller 18 may be further configured to detect whether the torque represents a change in load applied to hydraulic pump 28, as shown in step 245. Specifically, controller 18 may be configured to modify a fueling rate for power source 14, at step 250, based on the torque applied to hydraulic pump 16, when a change in load has occurred. Controller 18 may correlate the torque applied to hydraulic pump 16 with the fuel supply adjustment curve to determine a quantity of fuel adjustment to supply to power source 14 in order to maintain the engine speed and meet the power requirements of hydraulic pump 16. Controller 18 may continuously sense a value indicative of the torque applied to hydraulic pump 16, based on the method described above.

In an alternate embodiment, controller 18 may sum the measured torque applied to each of a plurality of hydraulic pumps 16 of machine 10. Controller 18 may then correlate the sum of the torque applied to each hydraulic pump 16 with the fuel supply adjustment curve to determine a quantity of fuel to supply to power source 14 in order to meet the collective torque consuming demands of hydraulic pumps 16 of machine 10. Controller 18 may provide a control signal for adjusting the fueling rate of power source 14 accordingly. It is contemplated that in an alternate arrangement, controller 18 may directly correlate the determined rotational time lag or the calculated twist angle with the fuel supply adjustment curve to determine a quantity of fuel to supply to power source 14.

### INDUSTRIAL APPLICABILITY

The disclosed methods may be applicable to any powered system that includes a power source and a load device, such as, for example, a hydraulic pump configured to convert at least a portion of the power from the power source into a flow of pressurized fluid for driving one or more fluid actuators associated with a ground engaging device or an implement circuit associated with an implement.

The disclosed system and methods may have particular applicability in determining torque applied to hydraulic pump 16 for use by controller 18 in machine 10. Specifically, controller 18 may continuously monitor the torque applied to hydraulic pump 16 and modify the fueling rate to compensate for load changes and provide a precise supply of fuel to power source 14. This may allow for accurate control of power source 14 during transient loading conditions of the hydraulic pump 16, and may result in less gaseous emissions and improved fuel economy.

Alternatively or additionally, the disclosed system and methods may be used to evaluate the performance of hydraulic pump 16. In particular, the disclosed system and methods may be used to measure the torque applied to hydraulic pump 16 at a known operating condition, i.e., fixed pressure, speed, or flow rate. If the torque applied to hydraulic pump 16 changes at the known operating condition during the lifetime of hydraulic pump 16, the deviation may indicate a problem with hydraulic pump 16.

It will be apparent to those'skilled in the art that various modifications and variations can be made to the disclosed systems and methods of the present disclosure without departing from the scope of the disclosure. Other embodiments will be apparent to those skilled in the art from consideration of the specification and practice of the embodiments disclosed herein. It is intended that the specification and examples be considered as exemplary only, with a true scope of the disclosure being intended by the following claims.

What is claimed is:

1. A method for power management in a machine, comprising:
sensing a parameter indicative of a torque applied to a torque consuming device rotatably driven by a power source; and
modifying a quantity of fuel supplied to the power source as a function of the sensed parameter.

2. The method of claim 1, further including correlating the sensed parameter with an applied torque value based on a predetermined relationship between the sensed parameter and the torque applied to the torque consuming device.

3. The method of claim 1, wherein modifying a quantity of fuel includes correlating an adjusted fuel quantity with torque applied to the torque consuming device based on a predetermined relationship.

4. The method of claim 1, wherein the sensing of a parameter indicative of a torque applied to a torque consuming device includes sensing of a parameter indicative of a change in torque.

5. The method of claim 1, wherein the torque consuming device is a hydraulic pump.

6. The method of claim 5, further including determining a twist angle of a pump shaft of the hydraulic pump based on the sensed parameter.

7. The method of claim 6, further including correlating the twist angle with a torque curve associated with the hydraulic pump to determine the torque applied to the hydraulic pump.

8. The method of claim 7, wherein modifying a quantity of fuel includes modifying the quantity of fuel based on the determined torque applied to the hydraulic pump.

9. The method of claim 1, wherein modifying a quantity of fuel supplied to the power source includes modifying the quantity of fuel to the power source such that a speed associated with the power source remains substantially the same during a change in load on the torque consuming device.

10. The method of claim 1, wherein sensing a parameter includes sensing a rotational time lag between different portions of a shaft of the torque consuming device.

11. A machine, comprising:
a frame;
an engine mounted to the frame;
one or more load devices operatively connected to the engine;
a controller in communication with the engine and the one or more load devices, the controller configured to regulate a quantity of fuel supplied to the engine based on a sensed change in load on the one or more load devices.

12. The machine of claim 11, wherein the controller is further configured to determine, based on a sensed parameter and a torque curve associated with each of the one or more load devices, a torque applied to the one or more load devices.

13. The machine of claim 11, wherein the one or more load devices includes one or more hydraulic pumps.

14. The machine of claim 11, wherein the controller includes a data indicative of measured load characteristics of the one or more load devices.

15. The machine of claim 14, wherein the data indicative of measured load characteristics is provided on the one or more load devices.

16. The machine of claim 15, wherein the data indicative of measured load characteristics is provided on a barcode of the one or more load devices.

17. The machine of claim 12, wherein the sensed change in load includes a sensed change in torque.

18. A method of generating a torque curve associated with a torque consuming device for use by a machine, the method comprising:
determining a twist angle of a shaft of the torque consuming device upon the application of a load to the torque consuming device;
measuring an actual torque applied to the shaft of the torque consuming device based on the applied load;
generating the torque curve based on a twist angle versus torque relationship; and
storing the torque curve on a medium associated with the torque consuming device.

19. The method of claim 18, wherein generating the torque curve further includes generating the torque curve during a torque consuming device end-of-line test.

20. The method of claim 18, wherein the medium is a barcode tag, and further including scanning the barcode tag into a controller of the machine.
